(19) United States
(12) Patent Application Publication
(10) Pub. No.: US 2026/0112081 A1
(43) Pub. Date: Apr. 23, 2026

(54) EMBEDDING-BASED VISUALIZATION SYSTEM USING CONCEPTUAL POLES FOR MULTI-MODEL ANALYSIS OF LANGUAGE MODEL EMBEDDINGS

(71) Applicant: Andrew S. Wigodsky, Omaha, NE (US)

(72) Inventor: Andrew S. Wigodsky, Omaha, NE (US)

(21) Appl. No.: 19/364,034

(22) Filed: Oct. 21, 2025

Related U.S. Application Data
(60) Provisional application No. 63/709,524, filed on Oct. 21, 2024.

(51) Int. Cl. G06T 11/20; G06F 3/04815; G06F 3/04845; G06F 40/40

(52) U.S. Cl. CPC G06T 11/26; G06F 3/04815; G06F 3/04845; G06F 40/40; G06F 2203/04806; G06T 2200/24

(57) ABSTRACT

A system for visualizing and comparing high-dimensional text embeddings from a language model is described. The system can receive embedding vectors for input concepts from a language model, where the embedding vectors are obtained for the language model without modifying or retraining the language model. The system can project the embedding vectors into a low-dimensional visual space defined by one or more conceptual pole pairs, where each conceptual pole pair includes predefined anchor embeddings representing divergent ends of a semantic dimension, and position the input concepts at points in the visual space using similarity measures for the embedding vector of each input concept relative to the anchor embeddings of each conceptual pole pair. The system can also generate an interactive graphical visualization of the plurality of input concepts in the visual space, where the interactive graphical visualization displays each input concept at its respective point in the visual space.

### CROSS-REFERENCE TO RELATED APPLICATIONS

The present application claims the benefit under 35 U.S.C. § 119(e) of U.S. Provisional Application Ser. No. 63/709,524, filed Oct. 21, 2024, and titled “Embedding-Based Visualization System Using Conceptual Poles for Analysis of Language Models, Bias Detection, and Fact Alignment,” which is herein incorporated by reference in its entirety.

### BACKGROUND

Machine learning can be used to train models, such as language models, for natural language processing tasks, such as language generation. Language models can acquire predictive power regarding syntax, semantics, and ontologies in human language, but they can also inherit inaccuracies and biases, e.g., when these biases are present in the data they are trained on.

### DRAWINGS

The Detailed Description is described with reference to the accompanying figures. The use of the same reference numbers in different instances in the description and the figures may indicate similar or identical items.

FIG. 1 is a diagrammatic illustration of a three-dimensional plot showing a visualization of concept embeddings from a single language model relative to three pairs of conceptual poles that define three axes, as provided by an embedding-based visualization system in accordance with example embodiments of the present disclosure.

FIG. 2 is a block diagram illustrating an embedding-based visualization system in accordance with example embodiments of the present disclosure.

FIG. 3 is another block diagram illustrating an embedding-based visualization system, such as the embedding-based visualization system illustrated in FIG. 2, in accordance with example embodiments of the present disclosure.

FIG. 4 is a flow diagram illustrating methods for comparative visualization and analysis of language model embeddings in accordance with example embodiments of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

Modern artificial intelligence language models (e.g., transformer-based models like GPT series, LLaMA, BERT, etc.) represent text as high-dimensional vectors known as embeddings. These embeddings capture semantic and contextual relationships learned from the models' training data. Different models, however, often produce embeddings that organize concepts in distinct ways due to differences in architecture or training corpora. For example, one model's embedding for the term “management” might be more similar (in vector space) to “process” than to “architecture,” while another model might show the reverse. Such differences can indicate underlying biases or divergent understandings of concepts. However, these distinctions are not readily apparent to users because conventional evaluations focus on model outputs (generated text), providing only indirect insight into the models' internal semantic representations.

Techniques exist to visualize high-dimensional data by projecting embeddings into lower dimensional space (for instance, principal component analysis (PCA) or t-distributed stochastic neighbor embedding (t-SNE), and more recently Uniform Manifold Approximation and Projection (UMAP) for embedding visualization). While these dimensionality-reduction methods convey some structure, they have notable drawbacks. PCA provides a linear projection that may not capture non-linear semantic structures and inevitably causes information loss by discarding lesser principal components. t-SNE and UMAP create non-linear projections that can reveal local clusters but often distort true distances or global relationships between points. Moreover, their outputs are not consistent across runs or models, making direct comparison between different models' embeddings difficult. In short, using such techniques to compare embeddings from multiple language models may obscure important differences or require careful re-alignment of each model's visualization.

Interactive embedding visualization tools exist but have significant limitations. For example, Google's Embedding Projector (2016) allowed exploration of a single model's embedding space (with limited support for user-defined axes), but it was limited to one embedding set at a time and did not facilitate direct comparisons between different models' embeddings. Uber's Parallax tool (2019) introduced user-defined semantic axes to inspect word embeddings (demonstrating bias analysis on a gender axis across two corpora), but it did not offer a unified real-time multi-model visualization or an integrated environment for bias and factual alignment analysis across multiple language models. In other words, prior solutions did not provide a way to align and compare several distinct models' embedding spaces concurrently in one view, nor did they address the need for dynamic, on-the-fly selection of concepts and axes tailored to user inquiries.

Another challenge is bias detection and fact alignment in language models. Biases (e.g., along gender or ethnic lines in word associations) might be subtly reflected in a model's embedding space, but revealing and quantifying these biases is difficult without a direct comparison framework. Similarly, determining whether a model's embeddings align with known facts or logical relationships (i.e., whether the model has a “correct” understanding of certain factual associations) is non-trivial. Existing approaches to detect bias or factual errors often involve retraining or fine-tuning models with additional data, which is costly and time-consuming. Yet there is an immediate need for tools to inspect and compare models' knowledge and biases directly from their embeddings without retraining, especially as organizations evaluate third-party models or multiple model versions quickly.

Furthermore, current embedding visualization tools (such as static 2D scatterplots or isolated single-model visualizations) do not fully enable real-time exploration of embedding spaces. Users are often unable to select custom concepts of interest on the fly or to see how multiple models position those concepts relative to one another in one unified view. There is a gap in the art for an interactive system that can integrate embeddings from different sources in real time, align them in a meaningful way, and allow user-driven exploration (such as rotating a 3D plot, filtering concepts, or switching comparative dimensions) to glean insights about model behavior, biases, or knowledge.

Accordingly, there is a need for a more flexible and intuitive approach to visualize and directly compare embeddings from multiple language models. Such an approach can preserve important semantic relationships, allow consistent cross-model comparison, highlight biases or factual inconsistencies, and/or operate in real time without requiring model retraining or extensive preprocessing.

The systems and techniques described herein address the above-identified needs by providing visualization that aligns and displays high-dimensional embeddings from one or more language models in a unified low-dimensional space using conceptual reference points (“conceptual poles”) as anchors. For example, systems and methods for visualizing high-dimensional text embeddings in two or three dimensions (with an optional time dimension) in an interactive manner are described. In contrast to traditional, purely mathematical dimensionality reduction, the systems and techniques of the present disclosure leverage human-interpretable concept axes to organize the visualization, thereby maintaining semantic interpretability and consistency across multiple models. The systems and techniques described herein enable side-by-side or overlaid comparisons of different models' embedding spaces, facilitating tasks such as bias detection, concept exploration, and fact alignment in an interactive, real-time environment.

The systems and techniques described herein can represent and compare the internal embedding spaces of language models in a human-interpretable visual form, using conceptual pole alignment as the alignment mechanism. For the purposes of the present disclosure, it shall be understood that the term “embedding” shall be understood to refer to a numeric vector (often high-dimensional, e.g., 512 or 1024 dimensions) that a language model assigns to a piece of text (such as a word, phrase, or document). The term “conceptual pole” shall be understood to refer to an anchor embedding corresponding to a particular concept or abstract idea and used as an endpoint of a visualization axis. Conceptual poles can be used in complementary pairs (like two ends of a spectrum or two contrasting categories). By aligning data point embeddings relative to conceptual poles, embeddings from different models can be plotted in a common coordinate system defined by those poles, despite originating from different source spaces.

The systems described herein provide comparative analysis of embeddings from various language models. The conceptual poles, or anchor embeddings representing opposing concepts, are used to create semantic axes, allowing high-dimensional text embeddings to be plotted without altering them or retraining the models. By aligning embeddings into a common 2D/3D space based on their similarities to the poles, the system enables direct comparisons of model semantics. An interactive interface is provided that offers functionalities like rotating views, selecting different pole pairs, and dynamically adding new concepts. The systems reveal model differences, identify biases, and verify factual consistency by comparing embedding positions against known references. The systems can provide real-time, interpretable techniques for visual model assessment, featuring embedding ingestion, concept-pole alignment visualization, comparative analysis, bias detection, and fact alignment.

As described herein, systems can include a combination of hardware and software components that perform the following high-level functions: (1) ingesting or obtaining embeddings from selected language models for a set of target concepts; (2) aligning these embeddings along one or more predefined conceptual axes defined by conceptual pole pairs (pairs of conceptually opposite or divergent anchor embeddings); (3) generating an interactive 2D or 3D visualization of the aligned embeddings such that the positions of points reflect their relationships to the conceptual poles (and hence to the underlying concepts); and (4) enabling user interaction and comparative analysis tools to interpret differences between models, detect biases, and verify factual relationships. In some embodiments, a temporal dimension (e.g., a “fourth dimension,” such as time) can be incorporated, e.g., via animation or a timeline slider, to illustrate changes in embedding positions over time or across different versions of a model.

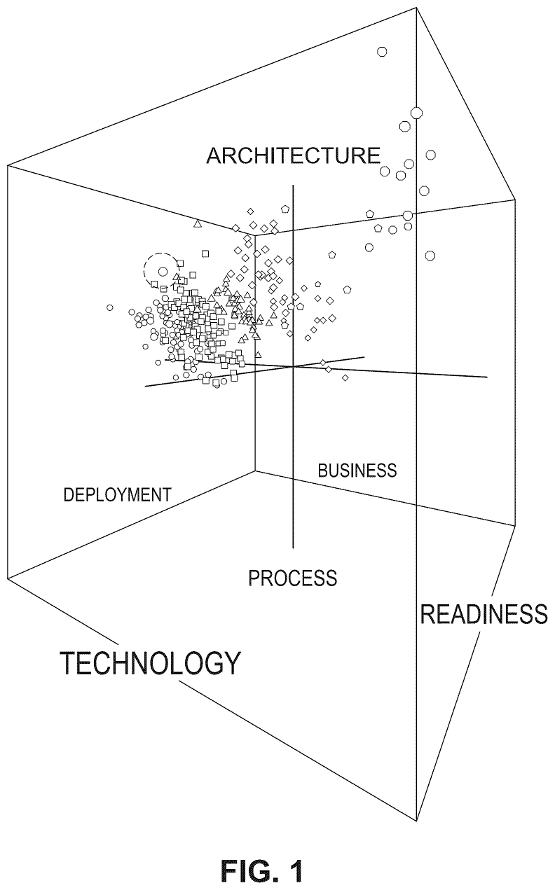

With reference to FIG. 1, an illustrative three-dimensional plot shows an example of how an embedding visualization system as described herein can visualize concept embeddings from a single language model relative to three pairs of conceptual poles that define three axes. In this schematic example, concepts derived from a security control framework are plotted with respect to axes such as “Architecture vs. Process,” “Readiness vs. Deployment,” and “Business vs. Technology.” Each point represents a concept, and its position indicates the model's interpretation of that concept along these axes. For instance, a point near the “Architecture” end of the first axis and near the “Business” end of the third axis would imply the model views that concept as more related to technical architecture and business contexts. Outlier points or distinct clusters can be easily identified. (FIG. 1 depicts a single model's embedding space; in other embodiments, multiple such plots or composite plots can be generated and compared for different models.)

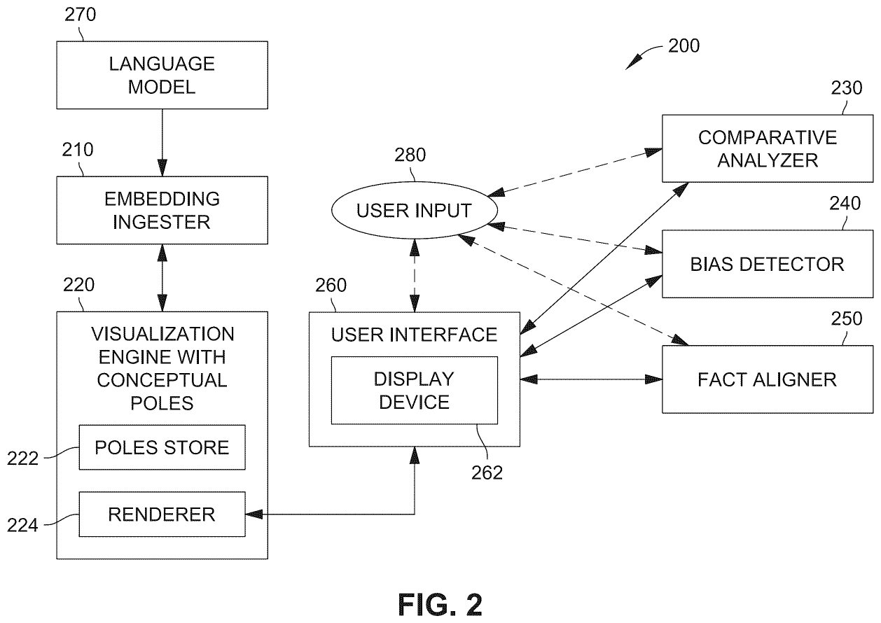

Referring now to FIG. 2, an architecture for an embedding visualization system 200 is described. The system 200 can include an embedding ingester 210, a visualization engine 220 with conceptual poles (which feeds into a rendering component for generating plot coordinates), a comparative analyzer 230, a bias detector 240, a fact aligner 250, and a user interface (UI) 260. Arrows are used to indicate data flow: embeddings can be fetched from external language models 270 into the embedding ingester 210, processed by the visualization engine 220 using the conceptual poles (which may be stored or predefined in the system), and then provided to the user interface 260 for display. The comparative analyzer 230, the bias detector 240, and the fact aligner 250 can operate on the processed data to generate additional annotations and/or visual cues (such as coloring certain points or generating alerts), and they can accept user input (e.g., the user selects a particular bias dimension to examine) to update the visualization.

The embedding ingester 210 can interface with one or more language models 270 to retrieve embeddings for selected input terms or concepts. For example, the embedding ingester 210 fetches embedding vectors from each chosen model for each concept. Language models can include, but are not necessarily limited to: generative transformer-based language models, masked language models, embedding-only models, fine-tuned versions of any of these models, and so forth. The system 200 can be configured to handle differences in embedding dimensionality or scale between different language models by internally standardizing calculations of similarities to conceptual pole pair anchor embeddings. In embodiments, the language models 270 may be accessed via local application programming interfaces (APIs), remote services, and so forth. The embedding ingester 210 can handle multiple models in parallel and may cache embeddings for efficiency. The input to the embedding ingester 210 can be a predefined set of concepts (for example, terms drawn from an external knowledge base or taxonomy) or ad-hoc terms chosen by a user. Embeddings can be gathered without altering or retraining the models. In some embodiments, if a concept consists of multiple words or a phrase, the embedding ingester 210 computes a composite embedding (e.g., by positional embedding or by averaging or aggregating the embeddings of constituent tokens for a phrase) to represent that multi-word concept. In this manner, each concept can yield a single representative vector per model. As described, the ingestion process is real-time capable, allowing on-demand retrieval when a user adds a new concept during analysis. In some embodiments, the system 200 can determine a composite embedding vector for an input concept that is represented by a multi-word phrase, a hierarchical combination of sub-concepts, an image or video, and so forth, by aggregating embeddings of sub-components of the input concept by calculating positional embeddings, averaging token embeddings, combining child concept embeddings, and so on, so that each input concept is represented by a single embedding vector regardless of its internal complexity.

The visualization engine 220 with conceptual poles can define one or more conceptual pole pairs (each pair representing opposite ends of a semantic spectrum or dimension) and uses them to align embeddings. For example, one conceptual pole pair might be “architecture” vs. “process” to represent a technical versus procedural dimension; another might be “business” vs. “technology”. Users or system designers can choose any concept pairs relevant to the analysis (e.g., “positive” vs. “negative” sentiment, “factual” vs. “misinformation,” or “female” vs. “male” for gender bias analysis).

The visualization engine 220 utilizes a set of conceptual pole pairs (which may be stored or configured in a conceptual poles store 222) to define semantic axes for visualization. The user or system 200 can select conceptual pole pairs that will serve as the axes of the plot. For each axis (each pole pair), the engine computes the position of each embedding relative to the two pole embeddings. In some embodiments, the cosine similarity of a data point's embedding to each pole is calculated. For example, an embedding's position along an “Architecture vs. Process” axis is determined by comparing its similarity to an “architecture” reference embedding versus a “process” reference embedding. By performing this for all defined axes, the engine assigns coordinates to every concept's embedding. The result is a unified coordinate space where each point's coordinates reflect that concept's relationship to the chosen semantic poles. The visualization engine 220 effectively aligns embeddings from different models into a common space without altering the embeddings themselves; their coordinates for visualization are computed based on conceptual references.

In an example, once the poles are established, the visualization engine 220 computes the position of each data point's embedding along each axis based on its similarity to each of the pole embeddings. In some embodiments, cosine similarity is used: for each axis, the relative cosine similarities of an embedding to the two poles determine where it falls between them. For example, similarity measures to determine the points can be cosine similarities between embedding vectors, such that, for each conceptual pole pair, the system 200 determines a first cosine similarity of the embedding for an input concept relative to the embedding for a first pole of a conceptual pole pair and a second cosine similarity relative to the embedding for a second pole of the conceptual pole pair, and then maps the input concept along the axis defined by the conceptual pole pair based on a comparison of the first cosine similarity and the second cosine similarity. By performing this for two or three independent axes (i.e., two or three distinct pole pairs), each data point can be assigned coordinates in a 2D or 3D space. Embeddings from different models are thus normalized and aligned according to these conceptually meaningful dimensions, preserving original semantic relationships in terms of the reference concepts, rather than using an arbitrary projection. The visualization engine 220 outputs the data necessary to plot each concept as a point in the coordinate system defined by the conceptual poles. However, it should be noted that cosine similarity measures are provided by way of example and are not meant to limit the present disclosure. In other embodiments, different similarity measures can be used, including, but not necessarily limited to, dot product techniques, Euclidean distance techniques, and so forth.

The visualization engine 220 can also include a renderer 224. The renderer 224 can prepare a graphical output (e.g., a 2D or 3D plot in Euclidean space) of the aligned embeddings. The renderer 224 takes the coordinates from the visualization engine 220 and generates the visual representation (e.g., plotting each concept as a point in a scatter plot). The comparative visualization can be rendered on a display device 262. The renderer 224 works closely with the user interface 260 to display the points and coordinate axes labeled by the concept poles. For a 3D representation, it can visualize axes and points in a three-dimensional space. For a 2D representation, it can generate a two-dimensional plot. Points can be rendered such that those from different models are distinguishable (e.g., using different colors or shapes per model as designated by the comparative analyzer 230).

The user interface 260 presents visualizations to the user and enables interactive exploration. Through the user interface 260, a user can manipulate a view (e.g., rotate a 3D plot, zoom in and/or out on a plot, pan across clusters in a plot) and query the data. The user interface 260 allows a user to filter displayed concepts, highlight and/or select specific points (to see details or compare across models), and switch between different conceptual pole pairs and/or add new concepts to the visualization. For instance, a user may select a different set of poles to see the embedding distribution under another semantic lens, which can trigger the visualization engine 220 to recompute coordinates and the user interface 260 to update the plot in real time. The user interface 260 also supports dynamic updates, such as immediately incorporating a newly fetched embedding when the user adds a concept (this ties back to the embedding ingester 210 retrieving new data and the visualization updating). In this manner, the user interface 260 manages user input 280 and translates it into updates in the visualization, creating an interactive, responsive experience.

Throughout the workflow, the system 200 can accept user input 280 to control the analysis. As described with reference to the accompanying figures, user input 280 represents the various ways a user can influence the system 200, e.g., selecting or uploading a set or sets of concepts to analyze, choosing and/or defining conceptual pole pairs, adjusting visualization settings, toggling analysis modes (comparative, bias check, fact alignment, etc.), and so forth. In this manner, the systems 200 described herein provide a flexible, user-driven exploration of embedding spaces.

The comparative analyzer 230 can manage the comparison of embeddings from multiple models within the unified visual space. In some embodiments, embeddings from different models for the same concept are displayed overlaid in one shared space (with distinct visual markers, such as different colors or shapes, for each model) or in separate but synchronized subplots side-by-side (e.g., as separate visual sub-panels within a display). For example, when two models (Model ‘A’ and Model ‘B’) are being compared, a user can see where Model ‘A’ places the concept “data privacy” relative to the poles versus where Model ‘B’ places the same concept relative to the same poles. The comparative analyzer 230 may tag each point with its source model and ensure that when points from multiple models are displayed together, they are rendered with distinct markers (e.g., displaying Model ‘A’ points as circles and Model ‘B’ points as triangles, using a first color or color range for Model ‘A’ points and a different color or color range for Model ‘B’ points, and so forth). In some embodiments, a system 200 can lock view orientations of separate visual sub-panels together, enabling a user to maintain a common perspective across the visual sub-panels when rotating, panning, and so forth, facilitating direct visual comparison of spatial arrangements between the language models.

The comparative analyzer 230 can compute quantitative metrics such as distances between different models' positions for the same concept (to quantify how differently the models embed that concept), cluster overlap measures or cluster statistics within each model's embedding distribution, an overall “centroid” representing each model's average position in the conceptual space, and so on. These metrics can be displayed to complement the visualization. For instance, quantitative insights can be presented to the user alongside the visualization (e.g., displaying a numeric “divergence score” for each concept between models). The comparative analyzer 230 allows toggling particular models or concepts on or off in the display (so the user can focus on one model at a time or see them combined) and ensures that if multiple models are shown, they use the same axes and scale for truthful comparison. It can also highlight a common reference concept (e.g., a “North Star”) across all models to provide a fixed benchmark for alignment. As described, the comparative analyzer 230 is active throughout the interactive process, updating comparative indicators as a user changes the view and/or data.

The bias detector 240 can facilitate identification and visualization of biases in the embedding spaces/language models. Bias detection can be achieved by selecting conceptual poles that correspond to known bias-prone dimensions (for example, genders of “male” vs. “female” as an axis pole pair) and examining where various concept embeddings fall along that axis and relative to those poles. In some embodiments, the bias detector 240 can automatically highlight certain points when a bias axis is in use, e.g., coloring occupation-related concept points to show their position on the gender axis, generating an alert if a significant bias is detected, and so forth. The system 200 can highlight potential biases by identifying if certain terms (e.g., occupation titles or other neutral terms) cluster closer to one pole than expected. In embodiments, the bias detector 240 can include predetermined lists of concepts that are expected to be neutral (such as job titles, which should not all cluster toward one gender pole). If the user engages a bias analysis mode through the UI, this module can respond by applying the relevant poles and providing visual cues (such as bias indicators or a summary score) to the user. For instance, if words like “nurse” or “receptionist” consistently plot nearer to the “female” pole while “engineer” or “leader” plot closer to the “male” pole for a given model, the visualization makes this bias apparent. In some embodiments, the bias detector 240 can provide statistical measures or alerts indicating bias, and users can interactively test different bias axes. In some embodiments, the system 200 can detect and/or visualize biases in language models by defining one or more conceptual pole pairs corresponding to a potential bias dimension, e.g., including at least one of a gender axis, an ethnicity axis, a sentiment bias axis, and so forth. A system 200 can then identify disparities in how points for respective input concepts from each language model are distributed relative to each bias-related conceptual pole pair, highlighting biased associations in the embeddings of the language models on the user interface 260. In some embodiments, a system 200 can provide an indicator, score, notification, etc. on the user interface 260 for a language model based on the points for a subset of the input concepts related to a particular bias category along a bias-related conceptual pole pair, where the indicator/score/notification quantifies a degree of bias in the embeddings of the respective language model.

The fact aligner 250 can evaluate how well embeddings align with known factual relationships, logical relationships, taxonomies, and so forth. In embodiments, the fact aligner 250 can leverage an external knowledge base or ground-truth dataset as a reference. For example, one approach is to use a taxonomy (such as a set of categories and sub-categories from a domain) and check if the model's embeddings cluster accordingly. In embodiments, the knowledge base can be a structured collection of domain-specific concepts and known relationships between the domain-specific concepts. The system 200 can derive a set of input concepts from the knowledge base, obtain corresponding embedding vectors such that the set of input concepts represent a defined domain or taxonomy, and then highlight, via the user interface 260, differences between the representations of a particular language model and a ground truth structure of a domain by visualizing the set of input concepts. The fact aligner 250 can identify concepts whose embeddings are placed in an unexpected location relative to known relationships, flagging potential misalignments. In some embodiments, the system can include a knowledge base of real-world relationships (geographic, hierarchical, etc.). The fact aligner 250 can check if concept embeddings that should be related appear near each other in the visualization and/or along expected axes. For instance, if the embedding for “Paris” is not near “France” in a model's space (and instead appears closer to unrelated concepts), the fact aligner 250 can highlight that anomaly.

Comparing multiple models can reveal which model's embeddings more accurately reflect reality (e.g., one model clusters country-capital pairs correctly while another does not). If a concept's embedding is far from where it “should” be according to factual data, the fact aligner 250 can flag it. For example, the user can select a “fact check” mode in the user interface 260 for a certain domain, prompting the fact aligner 250 to evaluate the positions of relevant concept points. Any anomalies (potential factual misalignments) can be highlighted in the visualization (e.g., an out-of-place point can be marked with an icon or different color). In this manner, the fact aligner 250 provides insight into whether a model's internal embeddings capture real-world relationships accurately. The fact aligner 250 also supports side-by-side model comparisons so a user can see which model's embeddings are better aligned with reality.

The user interface 260 provides an interactive graphical interface that can present 2D and/or 3D visualizations and allows user interaction in real time. The user interface 260 lets users rotate, zoom, and pan the visualization; hover over points to reveal the concept names and possibly additional details (like nearest neighbors or similarity values); and filter visible points by concept or model. Crucially, the interface allows dynamic updates: users can select different conceptual pole pairs or add new concepts on the fly and see the visualization update immediately. In multi-model scenarios, the user interface 260 can display multiple views side by side and/or overlay or juxtapose points from different models, with controls to synchronize views (so rotating one view rotates the others identically) for easy comparison. The interface can be intuitive so that even non-machine learning (ML) users can explore and understand the differences between model embeddings.

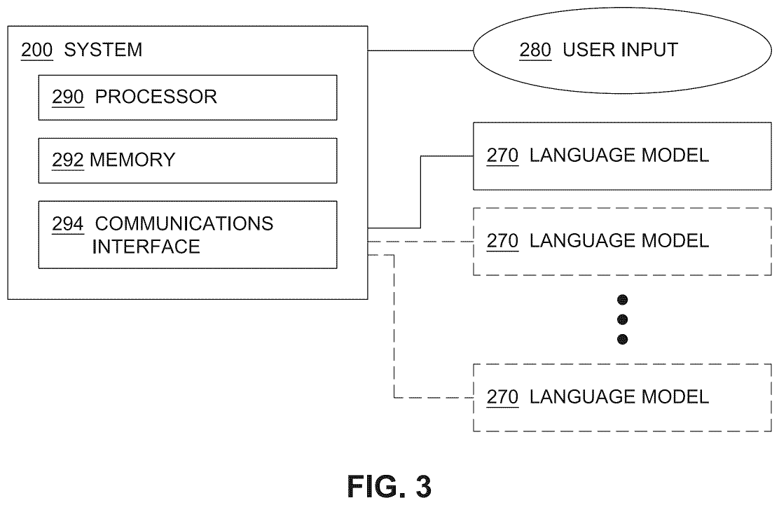

Referring now to FIG. 3, a system 200, including some or all of its components, can operate under computer control. For example, a processor 290 can be included with or in a system 200 to control the components and functions of systems 200 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 200. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The processor 290 provides processing functionality for the system 200 and can include any number of processors, micro-controllers, or other processing systems, and resident or external memory for storing data and other information accessed or generated by the system 200. The processor 290 can execute one or more software programs that implement techniques described herein. The processor 290 is not limited by the materials from which it is formed or the processing mechanisms employed therein and, as such, can be implemented via semiconductor(s) and/or transistors (e.g., using electronic integrated circuit (IC) components), and so forth.

The system 200 includes a memory 292. The memory 292 is an example of tangible, computer-readable storage medium that provides storage functionality to store various data associated with operation of the system 200, such as software programs and/or code segments, or other data to instruct the processor 290, and possibly other components of the system 200, to perform the functionality described herein. Thus, the memory 292 can store data, such as a program of instructions for operating the system 200 (including its components), and so forth. It should be noted that while a single memory 292 is described, a wide variety of types and combinations of memory (e.g., tangible, non-transitory memory) can be employed. The memory 292 can be integral with the processor 290, can comprise stand-alone memory, or can be a combination of both.

The memory 292 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 200 and/or the memory 292 can include removable integrated circuit card (ICC) memory, such as memory provided by a subscriber identity module (SIM) card, a universal subscriber identity module (USIM) card, a universal integrated circuit card (UICC), and so on.

The system 200 includes a communications interface 294. The communications interface 294 is operatively configured to communicate with components of the system 200. For example, the communications interface 294 can be configured to transmit data for storage in the system 200, retrieve data from storage in the system 200, and so forth. The communications interface 294 is also communicatively coupled with the processor 290 to facilitate data transfer between components of the system 200 and the processor 290 (e.g., for communicating inputs to the processor 290 received from a device communicatively coupled with the system 200). It should be noted that while the communications interface 294 is described as a component of a system 200, one or more components of the communications interface 294 can be implemented as external components communicatively coupled to the system 200 via a wired and/or wireless connection. The system 200 can also comprise and/or connect to one or more input/output (I/O) devices (e.g., via the communications interface 294), including, but not necessarily limited to: a display, a mouse, a touchpad, a keyboard, and so on.

The communications interface 294 and/or the processor 290 can be configured to communicate with a variety of different networks, including, but not necessarily limited to: a wide-area cellular telephone network, such as a 3G cellular network, a 4G cellular network, a 5G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 294 can be configured to communicate with a single network or multiple networks across different access points.

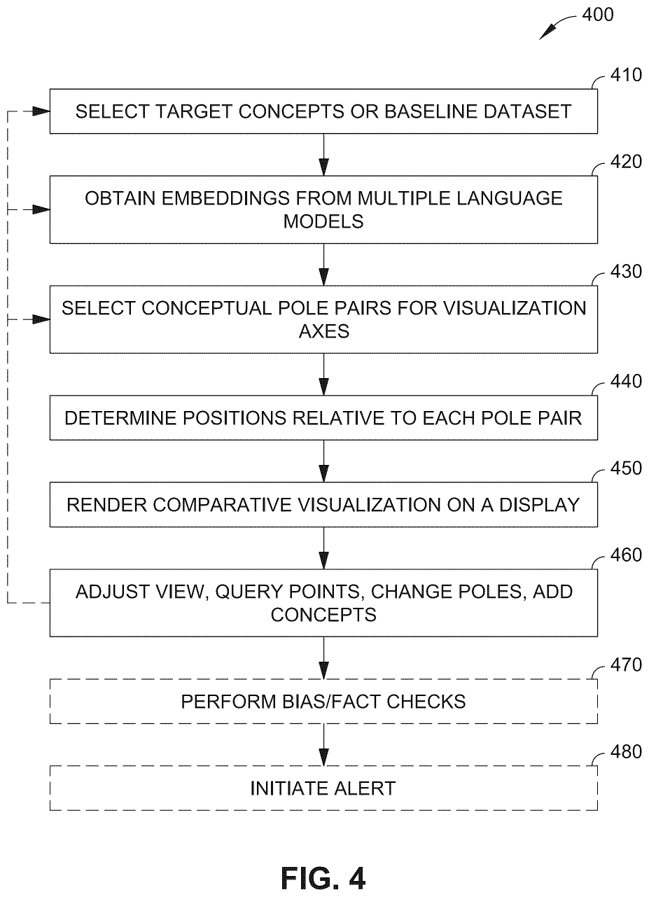

Referring now to FIG. 4, a process 400 for using conceptual poles to visualize and compare embeddings from multiple language models is depicted in accordance with example embodiments, e.g., as described with reference to the systems 200 discussed above with reference to FIGS. 1 through 3. In the process illustrated, target concepts or a baseline dataset is selected for analysis (Block 410). The process begins with identifying a set of concepts (words, terms, items) to be visualized. In embodiments, this may be a curated list of terms provided by a user or a baseline dataset of concepts drawn from a particular domain or application (e.g., a list of categories from a taxonomy, a list of terms relevant to a bias analysis, and so forth). For example, a system 200 accepts user input 280 to control the analysis. It shall be understood that concepts provided by a user can refer to direct user input (e.g., via the user interface) and also indirect user input (e.g., via a user's systems or software).

Next, embeddings from multiple language models are obtained (Block 420). For example, the embedding ingester 210 obtains embeddings from each of the chosen language models for each selected concept. This may involve querying external model APIs or local model instances. The embeddings for all concepts/model combinations are collected and prepared for alignment. In embodiments, the embedding ingester 210 ensures that each concept has one embedding per model, e.g., performing composite computations for multi-word concepts as needed.

Then, conceptual pole pairs are selected for visualization axes (Block 430). For instance, the user and/or a default configuration of a system 200 chooses one or more pairs of conceptual poles using the visualization engine 220 and conceptual poles store 222. These poles define the semantic dimensions that will structure the visualization. For example, a user may choose two poles to define an X-axis and two poles to define a Y-axis (for a 2D plot), or three pairs for X, Y, and Z (for a 3D plot). The poles can be pre-stored common axes or completely custom inputs from a user's selection. Once chosen, the system retrieves or computes the embeddings for these pole concepts (these may come from one of the models or be predefined vectors).

Next, positions for each concept's embedding are determined relative to each pole pair (Block 440). For example, the visualization engine 220 determines coordinates for every embedding. For each concept's embedding and each axis, a relative similarity to the two pole embeddings of that axis is determined (e.g., by computing cosine similarities to each pole). The visualization engine 220 then maps that embedding to a coordinate along the axis according to those similarities. In embodiments, positioning the input concepts in the visual space can be performed by normalizing coordinate values along each semantic dimension such that each conceptual pole of a conceptual pole pair anchors an extreme end of an axis in the visual space, with intermediate points for the input concepts interpolated between conceptual poles based upon the relative similarity measures. For instance, an embedding equally similar to both poles can be mapped to the midpoint of an axis, whereas an embedding more similar to one pole shifts the embedding toward that pole's end. Repeating for all axes yields a coordinate (x, y, z, . . . ) for the embedding in the unified space. This step aligns all embeddings from all models into the common conceptual space defined by the chosen poles.

Then, the comparative visualization is rendered on a display (Block 450). For example, the renderer 224 presents the comparative visualization via the user interface 260 (e.g., on the display device 262). The system 200 generates the visual plot of the embeddings. Each concept appears as a point in the 2D/3D scatter plot at the coordinates computed in the previous step. If multiple models are involved, each model's points can be marked distinctively. The axes can be labeled by the concept poles (e.g., an axis may be labeled “Architecture ← → Process”). The visualization is displayed to the user through the interface. At this stage, the user can see the initial arrangement of all selected concepts for all selected models in the conceptual space.

Next, the view can be adjusted, points can be queried, poles can be changed, concepts can be added, and so forth (Block 460). In this manner, an interactive loop is provided where updates occur immediately via the user interface 260. Once the visualization is shown, the user can engage with it. A user may rotate the 3D plot to view it from different angles, zoom in on a particular cluster of points (e.g., manipulations that do not require redetermination of coordinates, just re-rendering). The user can select a point to identify which concept it represents and compare it with its counterparts from other models (if overlaid). The user can also request additional information, such as nearest neighbor concepts to that point or exact similarity values. Crucially, the user can modify the visualization by changing the underlying parameters: for example, choosing a different conceptual pole pair for one of the axes (which would send the process back to Block 430 for that axis and then redetermine at Block 440 and update the plot at Block 450), adding a new concept to the set (going back to Block 410 for that concept and then retrieving its embeddings at Block 420, and so on), and so forth. Thus, a loop is provided where a user can iteratively explore the data; each adjustment triggers real-time updates to the visualization, maintaining an interactive experience.

In some embodiments, a user may perform optional bias/fact checks (Block 470). Additionally, one or more alerts can be initiated (Block 480). For example, using the bias detector 240 and/or fact aligner 250, a system 200 can check for biases. It should be noted that Blocks 470 and/or 480 may be performed at any point during the interactive loop, or as a final analysis step. In this manner, a system 200 can perform bias detection and factual alignment checks. If a user has enabled a bias axis or a fact alignment mode, the system can examine the current positions of points for patterns that indicate bias or factual anomalies. For instance, with a bias axis active, the system may detect that certain groups of concepts are skewed towards one pole and display an alert or special highlighting. Or with a knowledge base loaded, the system may flag concept points that are out of place. These checks provide the user with additional insights, such as a warning if a model shows an unusually strong bias or if it likely learned an incorrect association. The results of these checks are integrated into the visualization (e.g., coloring points or showing notification messages in the user interface 260). Throughout the above process, a system 200 operates to provide a real-time, interpretable, and interactive environment for comparative analysis of language model embeddings.

In some embodiments, the visualization can be animated or dynamically updated with changes in points of the input concepts over time (e.g., as a fourth dimension). For example, time-sequenced embedding data or embeddings from successive training epochs or versions of a language model can be used by a system 200 to show an evolution of the embedding space or differences between language model versions, e.g., using an animated visualization, a time slider, and so forth.

As described, systems 200 can implement real-time embedding retrieval. For example, a system 200 can support real-time or near-real-time operation. It can connect to external model APIs or local model instances to fetch embeddings on-demand as the user selects new concepts or changes axes. Because the alignment computations (based on similarity to conceptual poles) can be lightweight and deterministic, the visualization can update quickly without lengthy re-computation. This allows dynamic, exploratory analysis such that users do not need to precompute embeddings for all concepts or restrict themselves to a fixed dataset. A user can iteratively explore by adding concepts and/or adjusting axes, and the system can respond with updated visuals almost immediately.

In embodiments, systems 200 provide embedding-based visualization and analysis that improve over prior techniques by allowing multiple models' embeddings to be visualized together in a common interpretable framework (via conceptual pole alignment), facilitating direct comparisons of models. The systems 200 can employ conceptual poles as meaningful reference axes, which highlight interpretable differences and preserve important semantic relationships, in contrast to arbitrary mathematical projections. The systems 200 can also enable real-time, interactive exploration of embeddings without model retraining or heavy preprocessing, supporting dynamic user-driven analysis (e.g., allowing a user to quickly test a new bias hypothesis by adding a pole or concept and seeing instant results). The systems 200 can provide integrated tools for bias detection by examining how embeddings relate to bias-related axes across models, and factual consistency checking by referencing known truths and highlighting embedding misalignments, which can be critical for evaluating language models. Further, the systems 200 can maintain the integrity of each model's embedding space (e.g., where the embeddings themselves are not altered) while aligning them in a shared conceptual space, thus reflecting true differences rather than artifacts of a projection algorithm.

The systems and techniques described herein provide multi-model data alignment and interactive visualization together, which is particularly advantageous for examining complex AI models. Because the systems 200 leverage conceptual poles for alignment, the output visualization remains intelligible, i.e., axes correspond to concepts rather than abstract statistical components. The interactive nature of the systems 200 empowers users to become active participants in the analysis of language models. A user can quickly test ideas (for example, “Does Model X treat these concepts differently than Model Y along a sentiment axis?”) and get immediate visual feedback.

Not only does this approach avoid the need for any retraining of models, but it also scales to different models and domains easily. One can plug in off-the-shelf models and, by choosing relevant conceptual poles, inspect their embeddings with respect to domain-specific questions. The result is a tool that provides clarity on how different AI models internally represent information, helping researchers, developers, or auditors to diagnose model biases, verify knowledge, and make informed decisions about model usage or improvement.

By aligning embeddings from multiple models into one visual frame of reference, the systems and techniques described herein provide a direct comparative lens not available in prior single-model visualization tools. While the above descriptions detail specific embodiments and scenarios, it will be appreciated that the invention is not limited to those examples. Variations can be made without departing from the scope of the inventive concepts. For instance, different similarity metrics or mapping functions may be used, more than three axes may be visualized through multiplot arrangements or animations, systems 200 can be applied to embeddings of data types beyond text (such as image embeddings with analogous conceptual poles for visual concepts), and so forth.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A system for visualizing and comparing high-dimensional text embeddings from a plurality of language models, the system comprising:
one or more processors configured to receive a plurality of embedding vectors for a plurality of input concepts from a plurality of language models, the plurality of embedding vectors obtained for each language model without modifying or retraining the language model;
one or more memories having computer executable instructions stored thereon, the computer executable instructions configured for execution by the one or more processors to:
project the plurality of embedding vectors into a unified low-dimensional visual space defined by one or more conceptual pole pairs, each conceptual pole pair including two predefined anchor embeddings representing divergent ends of a semantic dimension, and
position the plurality of input concepts at points in the visual space using similarity measures for the embedding vector of each input concept relative to the anchor embeddings of each conceptual pole pair, thereby aligning respective embeddings from the plurality of language models in a common coordinate system; and
a user interface operatively configured to generate an interactive graphical visualization of the plurality of input concepts in the unified visual space, the interactive graphical visualization displaying each input concept at its respective point in the visual space, the user interface configured to facilitate exploration of the input concepts in at least two or three dimensions.

2. The system as recited in claim 1, wherein the computer executable instructions configured for execution by the one or more processors to:
simultaneously compare the plurality of language models by at least one of overlaying or juxtaposing representations of the plurality of embedding vectors from the plurality of language models within the interactive graphical visualization, and
determine one or more quantitative metrics indicating differences between placements of the representations of the plurality of language models for the same input concepts to be provided via the user interface.

3. The system as recited in claim 1, wherein positioning the plurality of input concepts in the visual space comprises normalizing coordinate values along each semantic dimension such that each conceptual pole of a conceptual pole pair denotes an extreme end of an axis in the visual space, with intermediate points for the plurality of input concepts interpolated between conceptual poles based upon relative similarity measures.

4. The system as recited in claim 1, wherein the one or more conceptual pole pairs are user-selectable or configurable, allowing a user to choose, via the user interface, different semantic dimensions for analysis, and, upon selection of a different conceptual pole pair, the points of the plurality of input concepts are updated in real time.

5. The system as recited in claim 1, wherein the computer executable instructions are configured for execution by the one or more processors to detect and visualize biases in the plurality of language models by
defining at least one conceptual pole pair corresponding to a potential bias dimension that comprises at least one of a gender axis, an ethnicity axis, or a sentiment bias axis, and
identifying disparities in how points for respective input concepts from each language model are distributed relative to the bias-related conceptual pole pair, thereby highlighting, via the user interface, biased associations in the embeddings of the plurality of language models.

6. The system as recited in claim 5, wherein the computer executable instructions are configured for execution by the one or more processors to provide an indicator or a score, via the user interface, for each language model based on the points of a subset of the plurality of input concepts related to a particular bias category along the bias-related conceptual pole pair, the indicator or score quantifying a degree of bias in the embeddings of the respective language model.

7. The system as recited in claim 1, wherein the computer executable instructions are configured for execution by the one or more processors to cross-reference embedding placements with a knowledge base of known relationships by
associating one or more of the conceptual pole pairs or points in the visual space with an expected factual relationship or category structure, and
identifying an input concept whose embedding vector is positioned in the visual space and deviates from an expected point implied by the knowledge base, thereby signaling that the understanding of a respective language model of the input concept may be misaligned with factual data.

8. The system as recited in claim 7, wherein the knowledge base comprises a structured collection of domain-specific concepts and known relationships between the domain-specific concepts, and the computer executable instructions are configured for execution by the one or more processors to
derive a set of input concepts from the knowledge base,
obtain corresponding embedding vectors such that the set of input concepts represent a defined domain or taxonomy, and
highlight, via the user interface, differences between the representations of a language model and a ground truth structure of a domain by visualizing the set of input concepts.

9. The system as recited in claim 1, wherein the computer executable instructions are configured for execution by the one or more processors to determine a composite embedding vector for an input concept that is represented by a multi-word phrase or a hierarchical combination of sub-concepts by aggregating embeddings of sub-components of the input concept by at least one of calculating positional embeddings, averaging token embeddings, or combining child concept embeddings, so that each input concept is represented by a single embedding vector regardless of its internal complexity.

10. The system as recited in claim 1, wherein the user interface supports interactive user operations including at least one of rotating and zooming the visual space, selecting or hovering over a point to reveal an identity of the input concept and contextual information including the points for other input concepts nearest to it in the visual space or a value of a similarity measure, filtering the displayed points by a concept or by a source language model, or dynamically adjusting one or more conceptual pole pairs, without requiring a restart or re-initialization of the system.

11. The system as recited in claim 1, wherein the computer executable instructions are configured for execution by the one or more processors to visually distinguish points originating from different language models within the unified visual space, by at least one of color-coding points according to each language model, using different point marker shapes according to each language model, or layering annotations according to each language model, so that a user can discern which language model an input concept point corresponds to while viewing a combined plot.

12. The system as recited in claim 1, wherein the interactive graphical visualization is a three-dimensional representation, the user interface displays the interactive graphical visualization for the embeddings of each language model in a separate visual sub-panel, and the computer executable instructions are configured for execution by the one or more processors to lock view orientations of the separate visual sub-panels together, enabling a user to maintain a common perspective across the visual sub-panels when rotating or panning, thereby facilitating direct visual comparison of spatial arrangements between the plurality of language models.

13. The system as recited in claim 1, wherein the computer executable instructions are configured for execution by the one or more processors to animate or dynamically update changes in points of the input concepts over time as a fourth dimension, wherein time-sequenced embedding data or embeddings from successive training epochs or versions of a language model are provided, such that the system shows an evolution of the embedding space or differences between a plurality of language model versions via at least one of an animated visualization or a time slider.

14. The system as recited in claim 1, wherein the computer executable instructions are configured for execution by the one or more processors to use an application programming interface (API) to request the embeddings from external language model services on demand, and the system is configured to update the interactive graphical visualization in real time in response to new input concepts being added by a user by obtaining the embeddings for the new input concepts via the API and immediately plotting the new points of the input concepts in the unified visual space.

15. The system as recited in claim 1, wherein the unified low-dimensional visual space is a two-dimensional or three-dimensional Euclidean space and the similarity measures used to determine the points comprises at least one of cosine similarities, dot product techniques, or Euclidean distance techniques between embedding vectors, such that, for each conceptual pole pair, the system determines a first cosine similarity of the embedding for an input concept relative to the embedding for a first pole of the conceptual pole pair and a second cosine similarity relative to the embedding for a second pole of the conceptual pole pair, and maps the input concept along an axis defined by the conceptual pole pair based on a comparison of the first cosine similarity and the second cosine similarity.

16. The system as recited in claim 1, wherein the plurality of language models includes at least two distinct models selected from the group comprising: generative transformer-based language models, masked language models, embedding-only models, and fine-tuned versions of any of the foregoing, and wherein the system is configured to handle differences in embedding dimensionality or scale between the plurality of language models by internally standardizing calculations of similarity to the conceptual pole pair anchor embeddings.

17. A computer-implemented method for interactive comparative visualization of text embeddings from a plurality of language models, the computer-implemented method comprising:
selecting, via an interactive user interface, a plurality of input concepts from a plurality of language models to analyze;
selecting, via the user interface, one or more conceptual pole pairs each including anchor embeddings defining a respective semantic axis for visualization;
receiving, by a processor and without modifying or retraining any one of the plurality of language models, a plurality of embedding vectors for the plurality of language models, the plurality of embedding vectors corresponding to the plurality of input concepts from the plurality of language models, each embedding vector representing a respective input concept in a high-dimensional embedding space of the respective language model;
determining, via the processor, coordinates in a common coordinate system by evaluating the relationships of the plurality of embedding vectors to each of the anchor embeddings for a conceptual pole pair in the selected one or more conceptual pole pairs, thereby transforming the plurality of embedding vectors into a coordinate frame defined by the anchor embeddings of the one or more conceptual pole pairs;
plotting, via a display device, a visual representation of points corresponding to the plurality of embedding vectors as defined by the coordinates in a two-dimensional or three-dimensional plot according to the coordinates;
causing the processor to distinguish using visual markings, via the display device, points originating from different ones of the plurality of language models; and
receiving, via the user interface, user instructions to manipulate the plot and to reveal information about the points, enabling a user to visually compare distributions of the points representing the input concepts across embedding spaces of the plurality of language models and to identify differences in semantic relationships indicated by their relative points along the respective semantic axes.

18. The computer-implemented method as recited in claim 17, further comprising causing the processor to:
dynamically update the visual representation in response to a user modifying the anchor embeddings of the selected one or more conceptual pole pairs or adding additional input concepts to the plurality of input concepts;
re-determine coordinates for points associated with each affected embedding vector; and
adjusting the plot in real time to update the points for the embedding vectors.

19. The computer-implemented method as recited in claim 17, further comprising causing the processor to:
provide user-interactive controls that enable a user to select at least one of a bias analysis mode or a fact alignment mode, and, in response, adjust the anchor embeddings of the selected one or more conceptual pole pairs to correspond to a respective bias-related dimension or a factual reference axis, respectively, and highlight, via the user interface, one or more points in the plot that indicate a potential bias or a factual misalignment in at least one of the plurality of language models.

20. The computer-implemented method as recited in claim 17, wherein determining, via the processor, coordinates in a common coordinate system by evaluating the relationships of the plurality of embedding vectors to each of the anchor embeddings for a conceptual pole pair in the selected one or more conceptual pole pairs comprises using at least one of cosine similarities, dot product techniques, or Euclidean distance techniques between embedding vectors to determine the relationship of each embedding vector to the anchor embeddings of the selected one or more conceptual pole pairs, and mapping each embedding vector to a point whose coordinate with respect to an axis is proportional to a difference between its cosine similarity to a first anchor of the axis and its cosine similarity to a second anchor of the axis.

21. A system for visualizing and comparing high-dimensional text embeddings from a language model, the system comprising:
one or more processors configured to receive a plurality of embedding vectors for a plurality of input concepts from a language model, the plurality of embedding vectors obtained for the language model without modifying or retraining the language model;
one or more memories having computer executable instructions stored thereon, the computer executable instructions configured for execution by the one or more processors to:
project the plurality of embedding vectors into a low-dimensional visual space defined by one or more conceptual pole pairs, each conceptual pole pair including two predefined anchor embeddings representing divergent ends of a semantic dimension, and
position the plurality of input concepts at points in the visual space using relative similarity measures for the embedding vector of each input concept to the anchor embeddings of each conceptual pole pair, thereby aligning respective embeddings from the language model in a coordinate system; and
a user interface operatively configured to generate an interactive graphical visualization of the plurality of input concepts in the visual space, the interactive graphical visualization displaying each input concept at its respective point in the visual space, the user interface configured to facilitate exploration of the input concepts in at least two or three dimensions.
